(19) United States
(12) Patent Application Publication
(10) Pub. No.: US 2007/0013476 A1
(43) Pub. Date: Jan. 18, 2007

(54) System to unlock doors

(76) Inventor: Dragan P. Petrovic, Geneva, IL (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/180,203

(22) Filed: Jul. 13, 2005

(51) Int. Cl. G05B 19/00; B60R 25/00

(52) U.S. Cl. 340/5.7; 340/5.52

(57) ABSTRACT

A door control system not only provides security to a region by keeping the door(s) locked, it also incorporates a door unlocking function usable as conditions warrant. Sensed medical or ambient conditions, such as smoke or gas, can cause the system to unlock the respective door(s).

### FIELD OF THE INVENTION

This invention pertains to building monitoring systems. More particularly, it pertains to such systems which incorporate door unlocking circuitry.

### BACKGROUND OF THE INVENTION

It has been recognized that members of an aging population scattered throughout the United States do best when they can continue to live in their homes or residences. Monitoring systems can be used to support such individuals in their normal and customary lifestyle at home. One such monitoring system has been disclosed in U.S. Pat. No. 6,402,691 entitled “In-Home Patient Monitoring System”. Another has been disclosed in pending U.S. patent application Ser. No. 10/956,681, filed Oct. 1, 2004 and entitled “Mobile Telephonic Device and Base Station”. The '681 application has been assigned to the assignee hereof and incorporated herein by reference.

One aspect of residential living involves the presence of doors which at times may be locked. The presence of locked doors may impede the resident or residents exiting the residence in the event of an emergency. Alternately, locked doors may impede neighbors, friends, relatives or professional care givers who may be trying to assist a respective resident in case of a health or other type of emergency if the resident is unable to unlock the door or doors of the residence.

There is a need for systems which can provide a door unlocking function in the event of a medical or other emergency. It would be preferable if such systems could be coupled to a local residential monitoring system and/or a building security system if one is present. It would also be preferable if such unlocking systems could be controlled from one or more displaced monitoring sites.

### BRIEF DESCRIPTION OF THE DRAWINGS

FIG. 1 is a top plan of a region wherein a system in accordance with the invention has been installed;

FIG. 2 is a block diagram of a portion of the system of FIG. 1;

FIG. 3 is a block diagram of a representative door locking/unlocking apparatus usable with the system of FIG. 1

### DETAILED DESCRIPTION

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

In accordance with the invention, a door locking system can be coupled to a local residential monitoring system. In the event that the monitoring system detects a condition at the residence which may require external follow up or intervention, it can notify a remote monitoring agency, or neighbor or relatives that the resident may need help. The same determination and signals can be simultaneously communicated to the door locking system which can in turn unlock one or more respective doors so as to provide easier access to the individual at the residence.

In one aspect of the invention, the monitoring system and the door locking system can be linked using either a wired or wireless medium. For example, conventional electrical wiring can be used. Alternately, the two systems can communicate wirelessly by RF, infrared or ultrasound.

Door locking mechanisms are known and can be coupled to the door locking system. They could, for example, be similar to door locking systems which are known and used in connection with hotels or motels. Alternately, an electromechanical device such as a solenoid driven locking mechanism can be attached to one or more of the doors of the residence. Such electromechanical mechanisms could then replace the original door locking mechanism. A local monitoring system can provide control signals to the door locking mechanism when the door is to be released or unlocked.

The electromechanical mechanisms can be energized using utilities supplied electrical energy or it can be battery operated. Where utility supplied power is primarily used, batter backup can be provided.

In one embodiment of the invention, selected individuals can be provided with a wireless, for example, RF responsive, key which can be used to activate the door locking system or the lock mechanism directly so as to unlock the door or doors from outside of the residence. Such keys could be used by persons having an interest in the resident's health such as relatives, friends, neighbors or agents of the monitoring agency. The keys can be overridden where the resident wishes to maintain privacy.

In another aspect of the invention, the door locking system could also be coupled to both building security and/or a fire protection system, if both are present at the residence. One or more doors can be automatically unlocked in the event of fire or other emergency not necessarily related directly to the resident. Such configurations would make it easier for first responders such as firemen, police, or emergency medical services to gain access to the residence if needed.

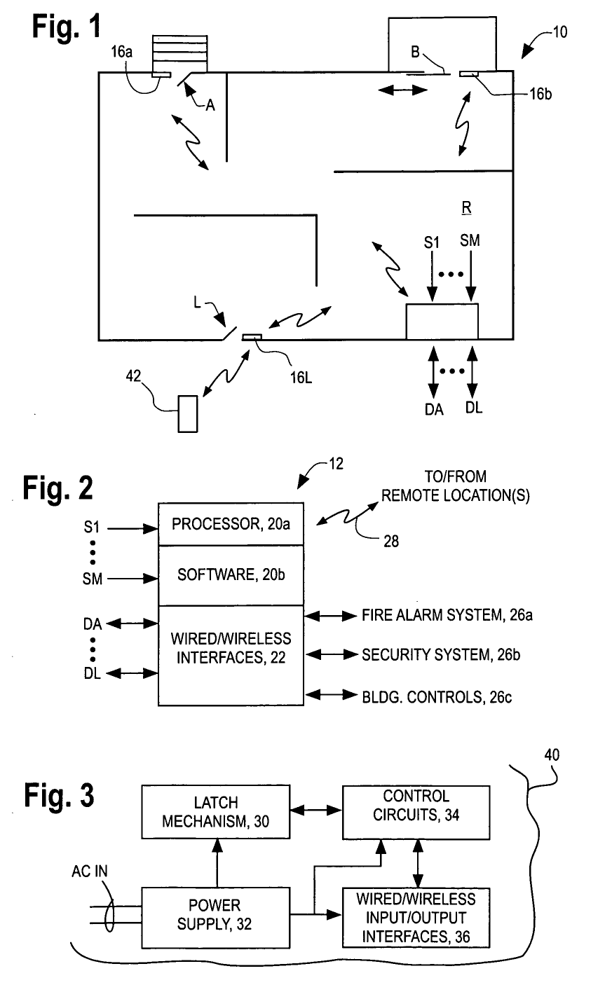

FIG. 1 illustrates a system 10 which embodies the present invention installed in a predetermined region R. The region R could be a living area of home, an apartment, an assisted living facility and the like all without limitation.

The system 10 incorporates a monitoring apparatus 12 of a type which would be known to those of skill in the art for monitoring one or more physiological parameters via sensors S1 . . . Sm of an individual who resides in the region R. The monitored parameters could include, but are not limited to, heart rate, blood pressure, temperature, respiratory rate, or any other physiological parameter of interest.

The sensors could, for example, be worn by the respective individual. The signals from the sensors S1 . . . Sm can be coupled, via a wired or wireless medium, to the apparatus 12.

The system 10 also incorporates a plurality 16 of door locking/unlocking devices such as 16a, 16b . . . 16l. The devices 16a, 16 . . . 16l are coupled to and associated with respective doors. These include rotatable doors A . . . l as well as sliding door B.

The door locking/unlocking devices 16a, 16b . . . 16l can be in wired or wireless communication with apparatus 12, indicated by a plurality of bidirectional signals Da . . . Dl. The devices 16a, 16 . . . 16l can be energized off of adjacent utility supply power, 110 volt ac with or without battery back-up, or, can be solely battery powered.

FIGS. 2 and 3 are block diagrams illustrating additional details of the apparatus 12 as well as a representative member of the plurality 16 of the door locking/unlocking devices such as 16i. The apparatus 12 could incorporate, for example, a programmable processor 20a and associated control software 20b. Further, wired/wireless interfaces 22 could be coupled to the programmable processor 20a and function under the control of the software 20b.

The physiological sensors indicated generally as S1 . . . Sm can couple values of selected physiological parameters to the apparatus 12 which in turn can carry out a variety of monitoring functions relative thereto. It will be understood that the particular monitoring functions which might be carried out are not limitations of the present invention.

Additionally, the interfaces 22 enable processor 20a to communicate, bidirectionally if desired, with the door locking/unlocking mechanisms such as 16a, 16b . . . 16l. Further, if desired the apparatus 12 could also be coupled to a fire alarm system 26a, a local building security system 26b, or building controls such as heating/AC or illumination 26c.

In the event of a condition developing where the resident might need assistance, whether based on physiologically measured parameters, signals from the fire alarm system, the building security system or building controls, the apparatus 12 can cause the respective door locking/unlocking mechanisms, such as the mechanism 16i, to unlatch the respective door or doors thereby providing access to assist the resident. In addition, if the resident is trying to leave the region R, the unlocked doors minimize any delays in this regard.

Unit 12, which could be a regional physiological monitoring system having the known capabilities of such systems, as for example in the '681 application incorporated by reference herein, could also include a communications port 28 for wired or wireless communication with a displaced location. Locations could include residences or offices of other family members, or, neighbors, or a remote monitoring location. Communications could be via one or more computer networks such as the Internet.

FIG. 3 is a block diagram representation of a typical one of the door locking/unlocking devices 16i. The device 16i incorporates a latch mechanism 30 which locks the respective door, such as the door i in a closed state. The mechanism 30 can be powered from utility supplied power and a local power supply 32. Alternately the mechanism can be actuated by battery supplied power.

The latch mechanism 30 can be implemented, for example, with the types of mechanisms used to provide key card access to rooms in hotels and motels. Alternately a solenoid-type latch release mechanism, battery or utility powered, can be used.

The unit 16i can also incorporate control circuitry 34 and a wired or wireless input/output interface 36. The control circuits 34 could also include a programmable processor and local control software. The unit 16i could be carried in a wall mountable housing 40.

In response to signals from apparatus 12, the respective door locking/unlocking units 16, such as unit 16i, can automatically unlatch the respective door such that the resident can easily leave the area. Alternately, a remote wireless key 42 could be provided to enable someone outside of the locked doors in the region R to quickly unlock the respective door or doors to assist the resident.

It will be understood the door locking/unlocking units 16, such as the unit 16i, could be disabled by apparatus 12 such that the wireless key entry device 42 is inoperative. In this way, during normal daylight hours, the resident could ensure his/her privacy. At night, the wireless keys such as 42 could be enabled to provide additional security for the resident.

Keys, such as key 42, could be equipped with one of a plurality of authorization codes. Such codes, which could be entered via unit 12, could provide varying degrees of access. For example, some codes could provide access only during predefined time periods or days. Alternately, some codes might unlatch only certain predefined doors. Others could provide unlimited access.

From the above, it will be observed that numerous variations and modifications may be effected without departing from the spirit and scope of the invention. It is to be understood that no limitation with respect to the specific apparatus illustrated herein is intended, or should be inferred. It is, of course, intended to cover by the appended claims all such modifications as fall within the spirit and scope of the those claims.

What is claimed:

1. An apparatus comprising:
a system for monitoring at least one physiological condition of an individual; and
first circuitry coupled to the system, and responsive thereto to unlock at least one door lock.

2. An apparatus as in claim 1 where the circuitry includes at least one door lock control port.

3. An apparatus as in claim 2 which includes second circuitry to unlock a plurality of door locks.

4. An apparatus as in claim 1 which includes second circuitry to lock the at least one door lock.

5. An apparatus as in claim 1 which includes a door control system coupled to the system for monitoring.

6. An apparatus as in claim 5 where the door control system responsive to an output from the system for monitoring generates a signal for one of locking or unlocking at least one door.

7. An apparatus as in claim 1 where the system includes at least one of a fire alarm system, an intrusion monitoring system, or, an environmental control system.

8. An apparatus as in claim 1 which includes communication circuitry that couples the system to the first circuitry.

9. An apparatus as in claim 8 where the communications circuitry includes at least one wireless transmitter.

10. An apparatus as in claim 8 which includes at least one wireless receiver responsive to a signal from a displaced location for unlocking the at least one door lock.

11. An apparatus as in claim 10 which includes circuitry for determining if the received signal from a displaced location should be accepted or denied.

12. An apparatus comprising:
a plurality of physiological sensors for monitoring respective parameters of an individual;
control circuitry coupled to the sensors, responsive to information received therefrom, for establishing the presence of a predetermined physiological condition of concern; and
a plurality of door latch/unlatch mechanisms coupled to the control circuitry, the control circuitry causing at least one of the mechanisms to enter an unlatched stated in response to the established presence of the condition of concern.

13. An apparatus as in claim 12 which includes a communications port for sending a message to a displaced location relative to the established presence of the condition of concern.

14. An apparatus as in claim 12 where at least some of the sensors are in wireless communication with the control circuitry.

15. An apparatus as in claim 12 where at least some of the mechanisms are in wireless communication with the control circuitry.

16. An apparatus as in claim 12 which includes a receiver of incoming access seeking wireless signals.

17. An apparatus as in claim 16 where the control circuitry determines if the access seeking wireless signals are in accordance with predetermined access criteria.

18. An apparatus as in claim 12 which includes a port to communicate with at least one of a fire alarm system, a building security system, or, a building environmental control system.

19. An apparatus as in claim 12 which includes physiological condition monitoring software, responsive to information received from the sensors.

20. An apparatus as in claim 17 where the control circuitry includes a plurality of pre-stored access codes to establish, at least in part the predetermined access criteria.
